(19) United States
(12) Patent Application Publication
(10) Pub. No.: US 2015/0000670 A1
(43) Pub. Date: Jan. 1, 2015

(54) PORTABLE MASK DEVICE

(71) Applicants: Eun-Soo Kim, Gyeongsangbuk-do (KR); Hyun-Ha Kim, Gyeongsangbuk-do (KR)

(72) Inventors: Eun-Soo Kim, Gyeongsangbuk-do (KR); Hyun-Ha Kim, Gyeongsangbuk-do (KR)

(21) Appl. No.: 14/002,434

(22) PCT Filed: Jan. 9, 2013
(86) PCT No.: PCT/KR2013/000165

§ 371 Date: Aug. 30, 2013

(30) Foreign Application Priority Data
Feb. 3, 2012 (CN) 10-2012-0011468

(51) Int. Cl. A62B 23/06

(52) U.S. Cl. CPC A62B 23/06
USPC 128/206.11

(57) ABSTRACT

The present invention relates to a portable mask device, comprising: a body which is partitioned by an inlet port provided at a predetermined inner position, and which includes a first space portion having an exhaust port formed at a predetermined position; a pair of nasal cavity insertion units which are spaced apart from each other at certain intervals at a predetermined position on the upper surface of the body; a cover which is detachably coupled with the upper part of the body; and a suction plate which is coupled with the lower part of the body, wherein an inlet film is coupled to the upper surface of the inlet port so as to open and close the inlet port and an exhaust film is coupled to the outer surface of the exhaust port so as to open and close the exhaust port.

### CROSS-REFERENCE TO RELATED APPLICATION

This Application is a Section 371 National Stage Application of International Application No. PCT/KR2013/000165, filed Jan. 9, 2013, the contents of which is hereby incorporated by reference in its entirety.

### BACKGROUND OF THE INVENTION

1. Technical Field

The present invention relates to a portable mask device, and more particularly, to a portable mask device which is capable of protecting a user from poison gas and against dust, and is portable.

2. Background Art

In general, masks axe developed for protecting users from polluted environment from which poisonous gases, vapors, toxic particles, and others are discharged out, and are essential tools in emergency circumstances because the number of people who have died due to poisonous gases generated from the polluted environment and from the fire.

Particularly, in many cases, people die from toxic gases rather than fire when a fire breaks out in an underground space, and hence, it is important to use a mask in the underground space.

Moreover, as casualties because of fires or disasters are increased, gas masks are provided at subway stations, airports, and other places, but general people cannot correctly wear the gas masks because they do not know how to use them.

Furthermore, such gas masks are too expensive and inconvenient to carry for a personal use of general people.

### DISCLOSURE

### Technical Problem

Accordingly, the present invention has been made in an effort to solve the above-mentioned problems occurring in the prior arts, and it is an object of the present invention to provide a portable mask device, which is easy to wear and carry so that general people can rapidly use to protect their respiratory organs in an polluted environment or at the scene of a fire and to safely avoid the polluted environment or the scene of the fire.

### Technical Solution

To achieve the above objects, the present invention provides a portable mask device including: a body divided by an intake port mounted at a predetermined position of the inside thereof, the body including a first space part, which has an exhaust port formed at a predetermined position of one side thereof and an air suction member disposed at a predetermined position of the inside thereof, and a second space part having an air filtering member mounted therein; a pair of nostril insertion parts spaced apart from each other at a predetermined position of an upper face of the body; a cover detachably joined to the top of the body for opening and closing the nostril insertion parts; and a suction plate joined to the bottom of the body so as to prevent the air filtering member from being separated from the second space part, wherein an inhalation film is joined to an upper face of the intake port for opening and closing the intake port, and an exhaust film is joined to an outer face of the exhaust port for opening and closing the exhaust port.

The air suction member includes: a motor joined to a joining portion downwardly protruding at a predetermined position of an upper face of the first space part; and a blade joined to a driving shaft of the motor.

An earth blocking part downwardly protrudes at a predetermined position of an inner face in a width direction of the cover.

A receiving part for receiving a battery which supplies electric power to the air suction member is formed at a predetermined position of one side in a width direction of the first space part, and an insertion hole to which the earth blocking part is inserted is formed at a predetermined position of an upper face of the receiving part.

A first dust-proof filter, zeolite, hopcaiite, activated carbon and a second dust-proof filter are arranged in order inside the air filtering member.

The exhaust port includes: a pair of joining grooves symmetrically formed at predetermined positions of an outer rim surface thereof; and an exhaust film cover joined to the joining grooves for preventing the exhaust film from being separated out.

The suction plate has a plurality of suction holes spaced apart from one another at regular intervals in a longitudinal direction of the suction plate.

### Advantageous Effect

As described above, the portable mask device according to the present invention is easy to wear and carry, so that general people can rapidly use to protect their respiratory organs in a polluted environment or at the scene of a fire and to safely avoid the polluted environment or the scene of the fire.

### BRIEF DESCRIPTION OF THE DRAWINGS

FIG. 1 is a perspective view of a portable mask device according to a preferred embodiment of the present invention.

FIG. 2 is an exploded perspective view of the portable mask device.

FIG. 3 is a side sectional view of the portable mask device.

FIG. 4 is a sectional view showing a used state of the portable mask device.

FIG. 5 is a sectional view of a portable mask device according to a modification of the present invention.

Explanation of essential reference numerals in drawings*

| | |
|---|---|
| 110: | body |
| 112: | first space part |
| 112a: | joining part |
| 114: | second space part |
| 116: | receiving part |
| 116a: | insertion hole |
| 120: | intake port |
| 122: | suction hole |
| 124: | through hole |
| 126: | inhalation film |
| 130: | exhaust port |
| 132: | exhaust hole |
| 134: | through hole |
| 136: | exhaust film |
| 137: | joining groove |
| 138: | exhaust film cover |
| 140: | air suction member |
| 142: | motor |
| 144: | blade |
| 150: | cover |
| 152: | earth blocking part |
| 160: | air filtering member |
| 170: | nostril insertion |
| 180: | suction plate |
| 182: | suction hole |

### MODE FOR INVENTION

Reference will be now made in detail to the prefer red embodiment of the present invention with reference to the attached drawings. It will be understood that thicknesses of lines or sizes of components illustrated in the drawings may be exaggerated for clarity and convenience in explanation.

Moreover, it will be understood that terms and words used in the specification and claims are defined in consideration of functions of the present invention, and may be changed according to users' or operators' intentions or according to custom. Therefore, it will be further understood that the words or terms should be defined based on the overall contents of this specification of the present invention.

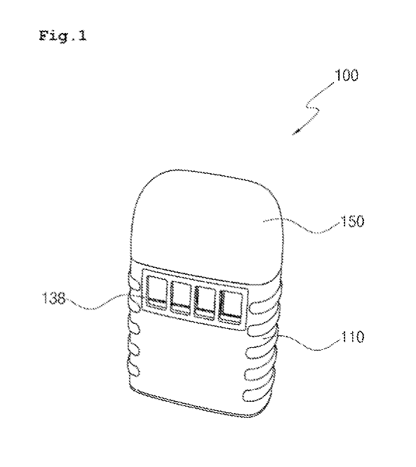

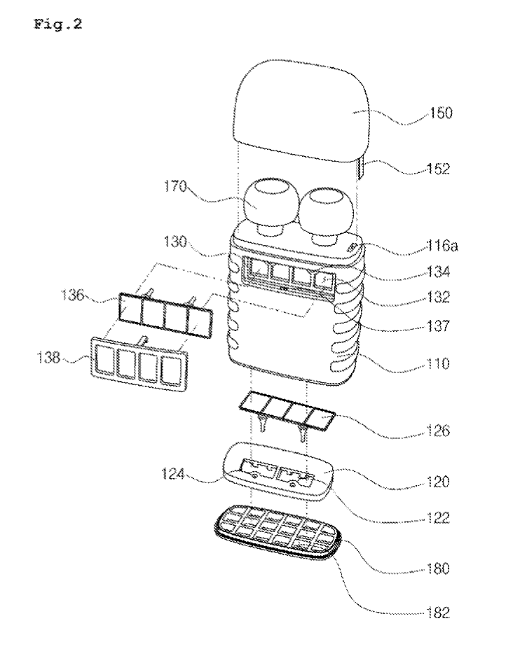

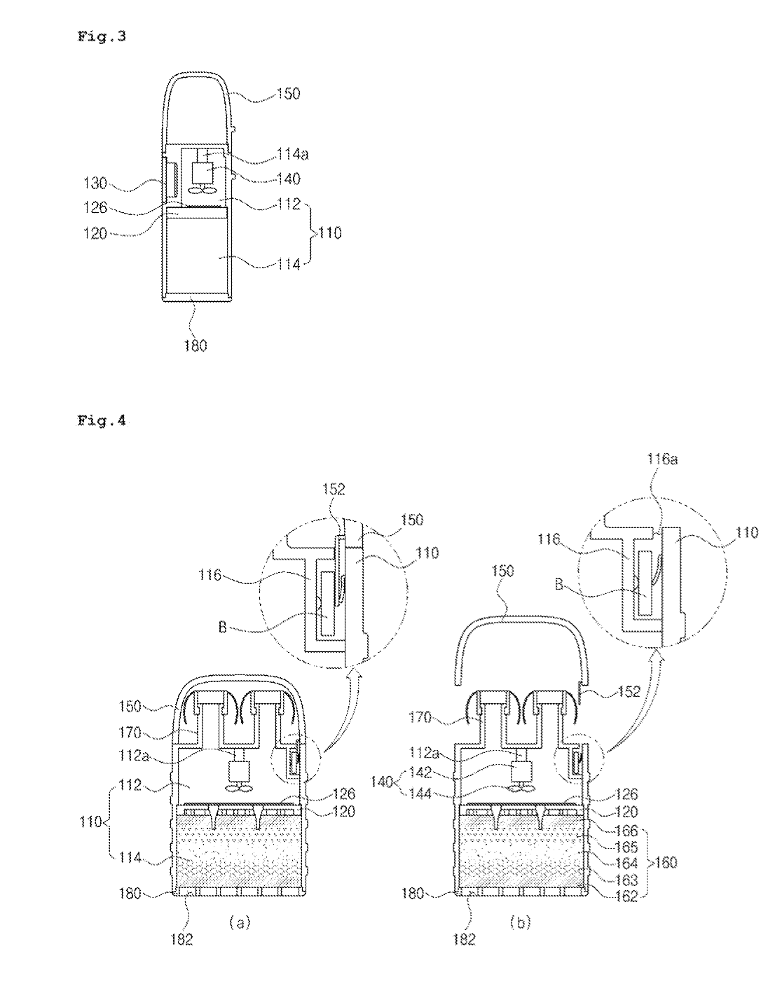

FIG. 1 is a perspective view of a portable mask device according to a preferred embodiment of the present invention, FIG. 2 is an exploded perspective view of the portable mask device, FIG. 3 is a side sectional view of the portable mask device, and FIG. 4 is a sectional view showing a used state of the portable mask device.

Referring to FIGS. 1 to 4, the portable mask device according to the preferred embodiment of the present invention includes a body 110, a cover 150, nostril insertion parts 170, and a suction plate 180.

The body 110 is divided by an intake port 120 mounted at a predetermined position of the inside thereof, and includes: a first space part 112 having an exhaust port 130 formed at a predetermined position of one side thereof and an air suction member 140 disposed at a predetermined position of the inside thereof; and a second space part 114 having an air filtering member 160 mounted therein.

The intake port 120 is formed in a plate shape and includes: at least one intake hole 122 formed at a predetermined position of a middle part; a pair of through holes 124 spaced apart from each other at predetermined positions of an upper face; and an inhalation film 126 joined to the through holes 124 for opening and closing the intake holes 122 of the intake port 120.

The exhaust port 130 includes: a plurality of exhaust holes 132 perforated at predetermined positions of one side of the first space part 112; a pair of through holes 134 spaced apart from each other at an outer face of the exhaust port 130; and an exhaust film 136 joined to the through holes 134 for opening and closing the exhaust holes 132 of the exhaust port 130.

Moreover, the exhaust port 130 further includes: a pair of joining grooves 137 symmetrically formed at predetermined positions of an outer rim surface thereof; and an exhaust film cover 138 joined to the joining grooves 137 for preventing the exhaust film 136 from being separated out.

The air suction member 140 includes: a motor 142 joined to a joining portion 112a downwardly protruding at a predetermined position of an upper face of the first space part 112; and a blade 144 joined to a driving shaft of the motor 142.

In this instance, it is preferable that the air suction member 140 is located inside the first space part 114 so as not to be crashed into the inhalation film 126 for opening and closing the intake hole 122 of the intake port 120.

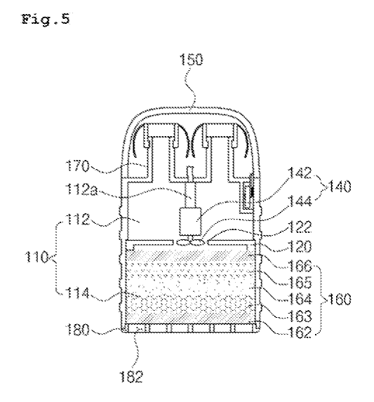

In the meantime, FIG. 5 is a sectional view of a portable mask device according to a modification of the present invention. Referring to FIG. 5, it is also possible that one intake hole 122 is for sued at the predetermined position of the middle part of the intake port 120 and the blade 144 of the air suction member 140 is located in the intake hole 122. In this instance, the inhalation film 126 for opening and closing the intake hole 122 of the intake port 120 is not used.

Furthermore, referring to FIG. 4, a receiving part 116 for receiving a battery B to supply electric power to the motor 142 of the air suction member 140 is formed at one side in a width direction of the first space part 112 in such a way as to be separated from the first space part 114. The receiving part 116 has (+) and (−) earth terminals which are respectively formed at both sides of the inside of the receiving part 116 and are electrically connected with the air suction member 140.

Additionally, the receiving part 116 has an insertion hole 116a formed at a predetermined position of an upper face thereof, and an earth blocking part 152 downwardly protruding at a predetermined position of an inner face in a width direction of the cover 150 which will be described later is inserted into the insertion hole 116a.

In addition, not shown in the drawings, but it is more preferable that one part of the outer face of the body 110 corresponding with the receiving part 116 is constructed in such a way as to be openable and closeable so as to replace the battery B contained in the receiving part 116.

The air filtering member 160 filters the air which is contained inside the second space part 114 and introduced from the outside. Such an air filtering member 160 includes: a first dust-proof filter 162 for removing dust introduced into the second space part 114; zeolite 164 for removing moisture contained in the air introduced into the second space part 114; hopcaiite 164 for removing smoke introduced into the second space 114; activated carbon 165 for purifying the air introduced into the second space part 114; and a second dust-proof filter 166 for removing remaining dust which is not removed by the first dust-proof filter 162.

In the air filtering member 160, preferably the first dust-proof filter 162, the zeolite 163, the hopcaiite 164, the activated carbon 165 and the second dust-proof filter 166 are stacked upwardly in order.

Moreover, of course, the air filter member 160 accommodated in the second space part 114 may be changed according to a user's intention.

The nostril insertion parts 170 are spaced apart from each other on the upper face of the body 110 and are inserted into the user's nostrils.

The cover 150 is detachably joined to the top of the body 110 so as to open and close the nostril insertion parts 170.

The earth blocking part 152 is formed at the predetermined position of the inner face in the width direction of the cover 150 and is inserted into the insertion hole 116a formed at the predetermined position of the upper face of the receiving part 116. It is preferable that the earth blocking part 152 is made of an insulating material.

As described above, when the cover 150 is joined to the top of the body 110, the earth blocking part 152 is inserted into the receiving part 116 through the insertion hole 116a in such a manner as to be located between the battery B and the earth terminal so as to block earthing between the battery B and the earth terminal.

In other words, when the cover 150 is joined to the top of the body 110, the earth blocking part 152 is inserted into the receiving part 116 through the insertion hole 116a so as to block earthing between the battery B and the earth terminal, so that operation of the air suction member 150. On the contrary, when the cover 150 is removed from the top of the body 110, the earth blocking part 152 is drawn out from the receiving part 116 through the insertion hole 116a, and hence, the battery B is earthed to the earth terminal, and the air suction member 140 is operated.

The suction plate 180 is joined to the bottom of the body 110 in order to prevent the air filtering member 160, which is accommodated in the second space part 114, from being separated from the second space part 114.

It is preferable that the suction plate 180 has a plurality of suction holes 182 spaced apart from one another at regular intervals in a longitudinal direction of the suction plate 180 so that the outside air can be introduced into the second space part 114.

Hereinafter, a used state of the portable mask device according to the present invention having the above-mentioned structure will be described.

First, the user removes the cover 150 from the body 110, and then, inserts the nostril insertion parts 170 into the user's nostrils. In this instance, the air suction member 140 disposed inside the second space part 114 is in operation.

After that, when the user breathes in air through the nostrils, the inhalation film 126 which opens and closes the intake hole 122 formed in the intake port 120 is separated from the intake port 120, and in this instance, the outside air is filtered through the air filtering member 160 accommodated inside the second space part 114, and then, is supplied to the user through the nostril insertion parts 170 after passing the first space part 112.

In this instance, the air suction member 140 promotes that the outside air is smoothly supplied to the user after being filtered through the air filtering member 160.

On the contrary to the above, when the user breathes out through the nostrils, the inhalation film 126 closes the intake hole 122 of the intake port 120, and at the same time, the exhaust film 136 which opens and closes the exhaust hole 132 of the exhaust port 130 is separated from the exhaust port 130 so as to discharge out the air.

As described above, the portable mask device according to the present invention is easy to wear and carry, so that general people can rapidly use to protect their respiratory organs in a polluted environment or at the scene of a fire and to safely avoid the polluted environment or the scene of the fire.

While the preferred embodiments of the present invention has been particularly shown with reference to the attached drawings, it will be understood by those of ordinary skill in the art that various changes, modifications and equivalents may be made therein without departing from the technical idea and scope of the present invention as defined by the following claims.

### INDUSTRIAL APPLICABILITY

The present, invention relates to a portable mask device, and more particularly, to a portable mask device which is capable of protecting a user from poison gas and against dust, and is portable.

What is claimed is:

1. A portable mask device comprising:
a body divided by an intake port mounted at a predetermined position of the inside thereof, the body including: a first space part having an exhaust port formed at a predetermined position of one side thereof and an air suction member disposed at a predetermined position of the inside thereof; and a second space part having an air filtering member mounted therein;
a pair of nostril insertion parts spaced apart from each other at a predetermined position of an upper face of the body;
a cover detachably joined to the top of the body for opening and closing the nostril insertion parts; and
a suction plate joined to the bottom of the body so as to prevent the air filtering member from being separated from the second space part,
wherein an inhalation film is joined to an upper face of the intake port for opening and closing the intake port, and an exhaust film is joined to an outer face of the exhaust port for opening and closing the exhaust port.

2. The portable mask device according to claim 1, wherein the air suction member comprises: a motor joined to a joining portion downwardly protruding at a predetermined position of an upper face of the first space part; and a blade joined to a driving shaft of the motor.

3. The portable mash device according to claim 1, wherein an earth blocking part downwardly protrudes at a predetermined position of an inner face in a width direction of the cover.

4. The portable mask device according to claim 3, wherein a receiving part for receiving a battery which supplies electric power to the air suction member is formed at a predetermined position of one side in a width direction of the first space part, and an insertion bole to which the earth blocking part is inserted is formed at a predetermined position of an upper face of the receiving part.

5. The portable mask device according to claim 1, wherein a first dust-proof filter, zeolite, hopcalite, activated carbon and a second dust-proof filter are arranged in order inside the air filtering member.

6. The portable mask device according to claim 1, wherein the exhaust port comprises: a pair of joining grooves symmetrically formed at predetermined positions of an outer rim surface thereof; and as exhaust film cover joined to the joining grooves for preventing the exhaust film from being separated out.

7. The portable mask device according to claim 1, wherein the suction plate has a plurality of suction holes spaced apart from one another at regular intervals in a longitudinal direction of the suction plate.
